(19) United States
(12) Patent Application Publication
(10) Pub. No.: US 2006/0040683 A1
(43) Pub. Date: Feb. 23, 2006

(54) Cellular radio telecommunications terminal, a system, a method, a computer program and a user interface

(75) Inventors: Kristian Lappalainen, Oulu (FI); Markku Heiskala, Oulu (FI); Tapio Turunen, Lempaala (FI); Antti Sinnemaa, Espoo (FI); Katja Konkka, Tampere (FI); Heli Jarventie, Tampere (FI); Albert Bitzer, Ottobeuren (DE); Christian Kraft, Hvidovre (DK)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/920,633

(22) Filed: Aug. 18, 2004

(51) Int. Cl. H04Q 7/38

(52) U.S. Cl. 455/466; 455/414.1; 455/552.1; 455/518; 455/1

(57) ABSTRACT

A cellular radio telecommunications terminal comprising: a cellular radio transceiver for receiving, as a plurality of data packets, a data sequence for output; processing means for processing the data sequence to produce an audio output to a user; a user interface for providing after the receipt of the data sequence, a user selectable option to process the data sequence; and means, responsive to the user selectable option of the user interface, for retrieving the data sequence; wherein the processing means is operable to process the retrieved data sequence to reproduce the audio output to the user. Also a system, a method, a user interface and a computer program on a record medium.

### FIELD OF THE INVENTION

Embodiments of the present invention relate to cellular radio telecommunications terminal, a system, a method, a computer program and a user interface. In particular, they relate to Push to Talk over Cellular and time-shifted voice communication.

### BACKGROUND TO THE INVENTION

Push to Talk over Cellular (PoC or PTT) introduces a direct one-to-one or one to many half-duplex voice communication service in the cellular network. The right to speak is granted on a first come first served basis by pushing a PTT key. While one person talks in a call group the others participants in the call group can only listen. Push to talk over cellular improves the efficiency of the cellular network in situations where people need to communicate with each other repeatedly but occasionally.

Typically PoC uses half-duplex voice over IP (VoIP) on an existing cellular packet data network such as General Packet Radio System (GPRS). Such cellular packet data networks can have always-on virtual (logical) connections between the network terminals of the network.

The use of half-duplex packet data channels as opposed to circuit switched full-duplex connections for voice communication results in network resources being reserved only one-way for the duration of call spurts (or bursts) instead of two way for an entire duration of a call.

A PoC call connection is almost instantaneous. A PoC burst is normally connected to the recipient(s) without the recipient(s) having to answer. The burst is typically reproduced via a terminal's loudspeaker (or if appropriate through a headset).

If a person wishes to talk then they press the PTT key when no one else participating in the call is talking and when they want to listen no action is required.

However, as no action is required to listen, a recipient may miss a call. e.g. if they are otherwise occupied or if there is background noise, or if they are at a distance from the terminal or if the terminal is in a silent mode.

It would therefore be desirable to time shift a PoC call so that it can be listened to by a recipient when it is convenient for the recipient.

### BRIEF DESCRIPTION OF THE INVENTION

According to one embodiment of the invention there is provided a cellular radio telecommunications terminal comprising: a cellular radio transceiver for receiving, as a plurality of data packets, a data sequence for output; processing means for processing the data sequence to produce an audio output to a user; a user interface for providing after the receipt of the data sequence, a user selectable option to process the data sequence; and means, responsive to the user selectable option of the user interface, for retrieving the data sequence; wherein the processing means is operable to process the retrieved data sequence to reproduce the audio output to the user.

According to another embodiment of the invention there is provided a system comprising: a first cellular radio telecommunications terminal comprising: a cellular radio transceiver for transmitting, as a plurality of data packets, a data sequence for output to a user of another terminal; a second cellular radio telecommunications terminal comprising: a cellular radio transceiver for receiving the data sequence within the plurality of data packets; processing means for processing the data sequence to produce an audio output to the user; a user interface for providing after the receipt of the data sequence, a user selectable option to process the data sequence; and means, responsive to the user interface, for retrieving the selected data sequence; wherein the processing means is operable to process the retrieved data sequence to reproduce the audio output to the user; and a memory for storing the data sequence.

According to another embodiment of the invention there is provided a method of communicating via a cellular radio telecommunications terminal comprising: receiving, as a plurality of data packets, a data sequence for audio output; providing after the receipt of the data sequence, a user selectable option to retrieve and process the data sequence to reproduce the audio output to the user.

According to another embodiment of the invention there is provided a computer program, which when loaded into a processor provides: means for presenting, after a data sequence that produces an audio output to a user has been received as a plurality of data packets, a user selectable option to retrieve and process the data sequence to reproduce the audio output to the user.

According to another embodiment of the invention there is provided a user interface, for a cellular radio telecommunications terminal, comprising, after a data sequence that produces an audio output to a user has been received as a plurality of data packets, a user selectable option to retrieve and process the data sequence to reproduce the audio output to the user.

Embodiments of the invention allow for the time shifting of a PoC call by enabling the data sequence for the call to be retrieved and processed to reproduce the audio output that was originally produced when the call was originally received.

Embodiments of the invention monitor background noise and are operable, in the presence of noise in excess of a predetermined level, to refrain from producing an audio output immediately in response to receipt of a data sequence, and to store the data sequence for subsequent retrieval and processing to reproduce the corresponding audio output to the user.

The user of the terminal is consequently able to use PoC in more varied circumstances than previously e.g. while the phone is in silent mode or there is a lot of noise.

The data sequence for a PoC call may be stored locally at the terminal. This has the advantage of reducing costs for the user. The user doesn't have to ask for a repetition of a message he did not hear correctly.

The user no longer has to reply immediately. This is suitable for situations in which the user cannot respond immediately because they are moving in traffic. For example, a bicycle courier in traffic may not hear an incoming call, but can pull in later in a quiet place and replay the missed call or calls.

### BRIEF DESCRIPTION OF THE DRAWINGS

For a better understanding of the present invention reference will now be made by way of example only to the accompanying drawings in which:

FIG. 1 schematically illustrates a system 1 enabling PoC;

FIG. 2 schematically illustrates a terminal 10 enabling PoC;

FIG. 3 schematically illustrates a method performed at a terminal according to a first embodiment; and

FIGS. 4A and 4B illustrate a user interface.

### DETAILED DESCRIPTION OF EMBODIMENTS OF THE INVENTION

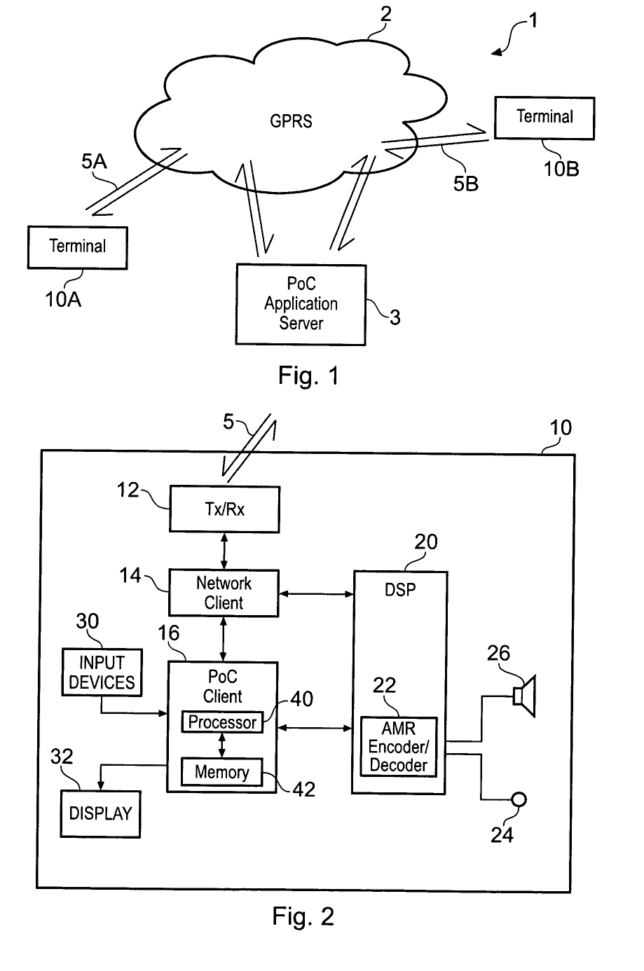

FIG. 1 illustrates a system 1 comprising a cellular radio telecommunications network 2, a Push to Talk over Cellular (PoC) application server 3 and a plurality of network terminals 10 including a first terminal 10A and a second terminal 10B.

The PoC application server 3 is connected to the cellular telecommunications network, in particular the packet data network. In this example, the packet data network is a GPRS network. The PoC application server 3 handles: PoC call set-up signaling; reservation of talk spurts for one speaker at a time; and real-time routing of IP packets carrying talk spurts to the recipients.

The first and second terminals communicate via respective radio interfaces 5A, 5B with the network 2. When operating as PoC terminals, the radio connection to the network 2 is a half-duplex connection carrying a series of radio packets. Each radio packet may comprise an IP packet and each IP packet comprises a plurality of AMR packets. Each AMR packet comprises data representing encoded speech or audio. Other encoding techniques could be used, and the invention is not limited to the use of IP and AMR packets.

FIG. 2 illustrates a terminal 10 in more detail. The terminal 10 comprises a cellular radio transceiver 12, a network client 14, a PoC client 16, Digital Signal Processing (DSP) circuitry 20 comprising an audio encoder/decoder 22, user input devices 30, a display 32, an audio input device 24 such as a microphone and an audio output device 26 such as a loudspeaker or earphone jack. The cellular radio transceiver 12 is connected to the network client 14, which is connected to the PoC client 16. The PoC client 16 is connected to the encoder/decoder 22 in the DSP 20. The decoder output of the encoder/decoder 22 is connected to the audio output device 26 and the encoder input to the encoder/decoder 22 is connected to the audio input device 24. One or more of these features may be implemented by hardware controlled by appropriate software.

The cellular radio transceiver 12 supports an always on connection to the network 2. When the terminal is operating as a PoC terminal, the cellular radio transceiver sends and receives (separately) radio packets via a radio connection to the network 2. At the IP level, the connection is half duplex. At other levels, particularly lower levels, a full duplex connection may be required.

The network client 14 includes content including IP packets received from the PoC client 16 in a GPRS radio packet that is then transmitted by the cellular radio transceiver 12 The network client 14 removes content from GPRS radio packets received by the cellular radio transceiver 12.

The PoC client may be provided by the combination of a microprocessor 40 and a memory 42 storing computer program instructions. The processor and memory may be used for other functions and are not necessarily dedicated to the PoC client functionality.

The DSP circuitry 20 may be used for digital signal processing other than the encoding/decoding of AMR packets received in PoC calls. For example, when ‘normal’ cellular telephone calls are received the DSP is used by the network client 14. The encoder/decoder comprises the Advanced Multi-rate (AMR) codec.

The user input devices 30 include a PTT key.

When the user of the terminal 10 wishes to talk in a call group, the PTT key is depressed. A signal is sent to the PoC client 16, which, via the network client 14, the cellular radio transceiver 12 and the cellular network 2, requests the PoC application server 3 to grant access to the PoC channel. The specification of the system may require access to be positively granted by a message sent from the application server 3 to the terminal 10. The PoC client 16, in response to the grant message if appropriate, enables audio encoding by the encoder/decoder 22 of the audio input at the audio input device 24. The speech input via the audio input device 24 is encoded as a data sequence and is provided as a series of AMR packets to the PoC client 16. The PoC client includes every three AMR packets in a separate IP packet. Each IP packet is then sent to the network client for inclusion in a GPRS radio packet that is then transmitted by the cellular radio transceiver 12 via the network 2 to the PoC application server 3.

The PoC application server 3 creates a copy of the GPRS radio packets for each participant in the call group and sends these packets to the participants.

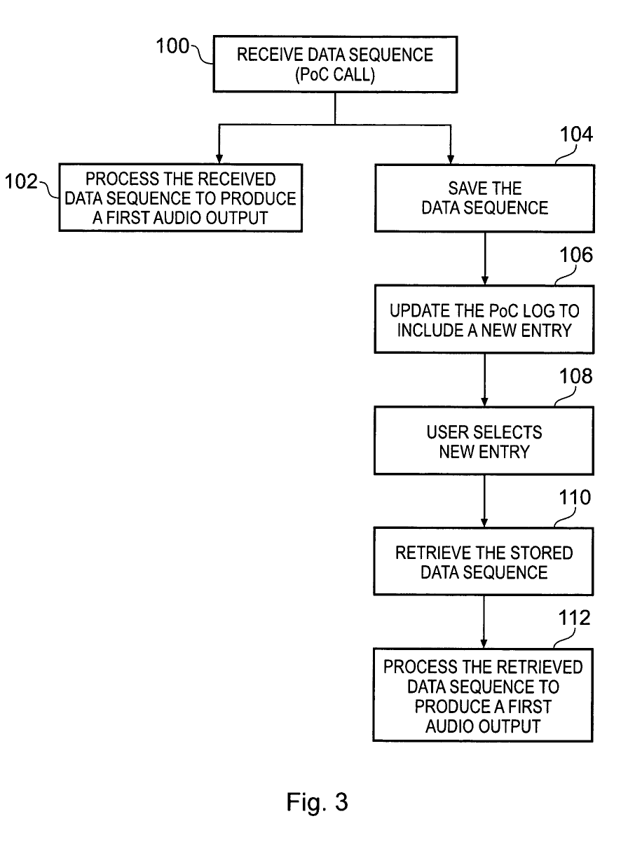

When the user of a terminal in the call group wishes to listen in a call group, no action is required. As illustrated in FIG. 3, a first data sequence is initially received at step 100. In this example, the first data sequence is processed on receipt, at step 102, to produce a first audio output.

At step 100, the radio cellular transceiver 12 of the terminal 10 receives a PoC GPRS packet from the PoC application server 3 via the cellular network 2. The network client 14 obtains the IP packet from within the received GPRS radio packet and the PoC client 16 processes the IP packet to obtain the AMR packets contained within. The PoC client 16 enables audio decoding by the encoder/decoder 22 and provides a data sequence, as a series of AMR packets, to it for decoding one at a time.

At step 102, the audio encoder/decoder 22 decodes the data sequence and uses the audio output device 26 to reproduce the original speech.

The DSP 20 thus processes the first data sequence of AMR packets on receipt to produce the first audio output to a user. The PoC client and DSP may automatically process a data sequence on receipt to produce an audio output to the user, automatically, without user action.

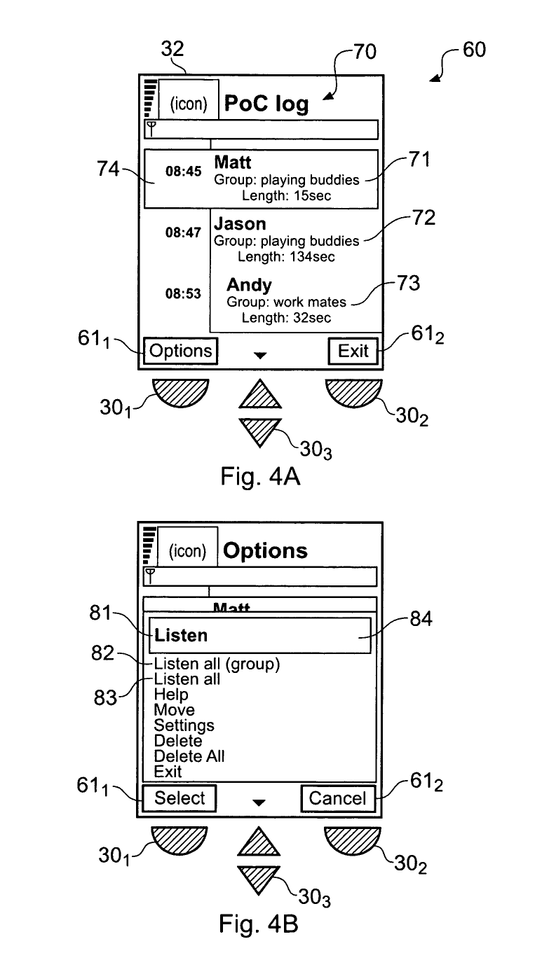

According to embodiments of the invention, a terminal 10 also comprises a user interface 60, as illustrated in FIGS. 4A and 4B, for providing after the receipt of the data sequence, a user selectable option to process the data sequence. The PoC client 16, responds to the user selection of the option by retrieving the data sequence. The DSP 20 processes the retrieved data sequence to reproduce the audio output that was produced when the data sequence was originally received.

The user interface 60 comprises the display 32 and the user input devices 30 for selecting options 62 presented on the display. The user input devices include a first programmable key 30₁ and a second programmable key 30₂. Each of the programmable keys has an associated legend 61₁ and 61₂. The legend associated with a key indicates its function at a particular time. As the function of the key changes then so does the content of its associated legend.

FIG. 4A illustrates a log 70 of received PoC bursts. The log 70 has a plurality of entries 71, 72, 73. Each entry is associated with a separate PoC burst and has an associated data structure that comprises information identifying the date/time when the associated PoC burst was received, identifying the originator of the burst, and identifying the call group to which the originator belongs. For example, in FIG. 4A, the highlighted entry 71 is associated with a PoC burst from Matt, of the call group ‘playing buddies’ received at 08:45.

The first programmable key 30₁ has the legend ‘Options’ and actuating the first programmable key 30₁ enters an Options menu illustrated in FIG. 4B for the currently highlighted entry.

A user is able to move a highlight 74 using scroll keys 30₃ to highlight any one of the entries before actuating the first programmable key 30₁.

When a new PoC burst is received, a new entry is made in the PoC log 70. In this example, the data sequence for the call is automatically processed, on receipt, by the DSP to produce an audio output to the user.

The Options menu 80 is illustrated in FIG. 4B. It has a plurality of different options 81, 82, 83 for selection. The first programmable key 30₁ has the legend ‘Select’ and actuating the first programmable key 30₁ selects a highlighted entry. A user is able to move a highlight 84 using scroll keys 30₃ to highlight any one of the entries before actuating the first programmable key 30₁′. The options include a first option 81 ‘Listen’. Selection of this option replays the PoC burst associated with the entry selected in the PoC log 70 i.e. in this example, the burst from Matt, received at 08:45. The options include a second option 82 ‘Listen all (group)’. Selection of this option replays in order the most recent PoC bursts of the call group of the entry selected in the PoC log 70 i.e. in this example, the most recent PoC bursts of the call group ‘playing buddies’ which would include the PoC burst from Matt, followed by the burst from Jason. The options include a third option 83 ‘Listen all’. Selection of this option replays the most recently received PoC bursts in order.

The user interface 60 may also comprise a user selectable option “settings” which gives access to a further menu (not shown) which allows the user to select the number of calls replayed when the second and third options 82, 83 are selected. This may be achieved by specifying a maximum replay time or a maximum number of bursts for example.

In a simpler alternative, only one option is provided for listening, which replays the most recently received burst, or the received bursts in reverse chronological order. This alternative allows for simpler user control.

When a user selectable option 81, 82, 83 is selected the data sequence for the burst or the data sequences for the bursts are retrieved and processed by the DSP 20 to reproduce the corresponding audio output to the user.

The user interface 60 may also comprise a user selectable option (not shown) for storing a retrieved PoC burst permanently.

In a first embodiment, when a PoC burst is initially received at the terminal it is automatically stored, without user action, in a local memory 42 from where it is retrieved when one of the user selectable options 81, 82, 83 is selected. The memory operates as a dynamic buffer for storing the data sequences of PoC bursts. As a new burst is received the newly received data sequence is stored. The data sequences are stored as a sequence of AMR packets. The data sequence may be stored as a part of the data structure The process is illustrated in more detail in FIG. 3. The available memory capacity may limit the number of data sequences which are retained. For example, a maximum may be set for the number of sequences stored, with the oldest currently stored sequence being deleted when a new sequence is stored. Alternatively, data sequences may be stored until a specified area of memory is full, the oldest sequence then being deleted in turn, beginning with the oldest, until enough space is available to store a new sequence. In a further alternative, each data sequence may be stored for a set period of time, after which it is deleted. Data sequences may be stored as RTP (Real-time Transport Protocol) packets, or as compressed RTP packets so that the loss of any packets, for example because of channel re-selection, is properly concealed during later audio reproduction of the data sequence.

After the first data sequence or stream is received at step 100, the PoC client 16 at step 104, stores the received data sequence to the memory 42. The PoC client 16 then creates an new entry in the PoC log 70 at step 106. If the user selects this entry for replay from the user interface 60 at step 108, then the PoC client at step 110, retrieves from the memory 42 the first data sequence and at step 112 the DSP 20 processes the retrieved data sequence and reproduces the first audio output.

In the first embodiment, the user interface 60 may also comprises a user selectable option (accessed through the ‘settings’ option) for switching the automatic storage of received data sequences on or off. The user interface may further comprise user selectable options (accessed through the ‘settings’ option) for specifying whether the PoC bursts for each of the call groups, should be automatically stored or not.

The Options menu also includes a Delete option and a Delete All option. Selection of the Delete option causes the previous PoC call to be deleted from memory 42. Selection of the Delete All option causes the deletion of all PoC calls currently stored in the memory 42.

The terminal 10 may also have a vibrating alert, which is activated whenever there is an incoming PoC burst. This allows a user to feel the incoming PoC burst even if they cannot hear it and prompts them to retrieve and replay the call.

In a second embodiment, when a PoC burst is initially received at the terminal it is automatically stored, without user action, in a remote memory 42 from where it is retrieved when one of the user selectable options 81, 82, 83 is selected. Typically, the remote memory is located in the terminal that originated the PoC burst. When a user selects an option 81, 82, 83 from the options menu, the terminal sends requests to the respective terminals requesting them to retrieve and re-send the PoC bursts.

In any embodiment, the microphone 24 may be used to monitor background noise around the terminal 10, at the time a data sequence is received. If the background noise exceeds a predetermined level, which may be pre-set by the user, the data sequence is automatically stored for subsequent retrieval and processing, as described above, but is not immediately processed to produce an audio output. Thus, in the presence of excessive background noise, either embodiment may refrain from executing step 102 immediately in response to receipt of a data sequence.

The inventive operation of the PoC client 16 in the embodiments of the invention is typically controlled by a computer program stored in the memory 42. The computer program, when loaded into a the microprocessor 40 provides: means for presenting, after a data sequence that produces an audio output to a user has been received as a plurality of data packets, a user selectable option to retrieve and process the data sequence to reproduce the audio output to the user.

The computer program instructions may be transferred to the memory via a record medium or carrier such as a CD-ROM, DVD, floppy disk, solid state memory etc or via a electromagnetic carrier signal received at the cellular radio transceiver. The computer program instruction, when loaded in to the microprocessor 40, control the operation of the PoC client 16.

Although embodiments of the present invention have been described in the preceding paragraphs with reference to various examples, it should be appreciated that modifications to the examples given can be made without departing from the spirit and scope of the invention.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A cellular radio telecommunications terminal comprising:
a cellular radio transceiver for receiving, as a plurality of data packets, a data sequence for output;
processing means for processing the data sequence to produce an audio output to a user;
a user interface for providing after the receipt of the data sequence, a user selectable option to process the data sequence; and
means, responsive to the user selectable option of the user interface, for retrieving the data sequence;
wherein the processing means is operable to process the retrieved data sequence to reproduce the audio output to the user.

2. A terminal according to claim 1, wherein the received data sequence is processed on receipt to produce an audio output.

3. A terminal as claimed in claim 1, wherein the user selectable option is for processing the most recently received data sequence.

4. A terminal as claimed in claim 1, wherein the user selectable option enables the selection for processing of at least one of a plurality of received data sequences.

5. A terminal as claimed in claim 1, wherein the user selectable option enables the selection for processing of one or more received data sequences associated with a predetermined group of communicating terminals.

6. A terminal as claimed in claim 1, further comprising a memory for storing the data sequence.

7. A terminal as claimed in claim 6, wherein the received data sequence is automatically stored in the memory without user action.

8. A terminal as claimed in claim 6, wherein the user interface further comprises a user selectable option to switch the automatic storage of received data sequences on or off.

9. A terminal as claimed in claim 6, wherein the received data sequence is stored as a sequence of AMR or RTP packets.

10. A terminal as claimed in claim 6, wherein the memory is for storing a plurality of data sequences each of which is stored in a data structure comprising identifying information.

11. A terminal as claimed in claim 10, wherein the identifying information includes one or more of: a date/time of receipt, an identification of the origin of the data sequence.

12. A terminal according to claim 1, further comprising background noise detector means operable to detect background noise, the processing means being operable to store the data sequence without being reproduced, if the background noise at the time of receipt of the data sequence is in excess of a predetermined level.

13. A terminal as claimed in claim 1, wherein the user interface further comprises user selectable options to enable/disable, for each of a plurality of different predetermined groups of communicating terminals, the automatic storage of received data sequences.

14. A terminal as claimed in claim 1, wherein the processing means is operable to automatically process the data sequence on receipt to produce the audio output to the user, automatically, without user action.

15. A terminal as claimed in claim 1, wherein the data sequence is encoded speech from a user of another terminal and the output is an audio output reproducing the speech.

16. A terminal as claimed in claim 1, wherein the processing means comprises an AMR decoder.

17. A terminal as claimed in claim 1, wherein the cellular radio transceiver supports an alwayson connection to a cellular radio telecommunications network.

18. A terminal as claimed in claim 1, wherein the data sequence is received via a half-duplex radio connection to a cellular radio telecommunications network.

19. A terminal as claimed in claim 1, wherein the data sequence comprises a series of IP packets.

20. A terminal as claimed in claim 1, wherein each IP packet comprises multiple AMR packets.

21. A terminal as claimed in claim 18, wherein each IP packet is comprised in a radio packet received by the cellular radio transceiver.

22. A system comprising:
a first cellular radio telecommunications terminal comprising:
a cellular radio transceiver for transmitting, as a plurality of data packets, a data sequence for output to a user of another terminal;
a second cellular radio telecommunications terminal comprising:
a cellular radio transceiver for receiving the data sequence within the plurality of data packets;
processing means for processing the data sequence to produce an audio output to the user;
a user interface for providing after the receipt of the data sequence, a user selectable option to process the data sequence; and
means, responsive to the user interface, for retrieving the selected data sequence;
wherein the processing means is operable to process the retrieved data sequence to reproduce the audio output to the user; and
a memory for storing the data sequence.

23. A system as claimed in claim 22 wherein the memory is located at the second terminal.

24. A system as claimed in claim 22 wherein the memory is located remotely from the second terminal.

25. A system as claimed in claim 23 wherein the memory is located at the first terminal.

26. A method of communicating via a cellular radio telecommunications terminal comprising:
receiving, as a plurality of data packets, a data sequence for audio output; providing after the receipt of the data sequence, a user selectable option to retrieve and process the data sequence to reproduce the audio output to the user.

27. A computer program, which when loaded into a processor provides: means for presenting, after a data sequence that produces an audio output to a user has been received as a plurality of data packets, a user selectable option to retrieve and process the data sequence to reproduce the audio output to the user.

28. A record medium embodying the computer program as claimed in claim 27.

29. A user interface, for a cellular radio telecommunications terminal, comprising, after a data sequence that produces an audio output to a user has been received as a plurality of data packets, a user selectable option to retrieve and process the data sequence to reproduce the audio output to the user.
